(19) United States
(12) Patent Application Publication
(10) Pub. No.: US 2016/0255800 A1
(43) Pub. Date: Sep. 8, 2016

(54) Device for Storing and Dispensing Dairy Products

(71) Applicants: Andrew J. Powell, III, North Myrtle Beach, SC (US); Phillip V. Jones, North Myrtle Beach, SC (US)

(72) Inventors: Andrew J. Powell, III, North Myrtle Beach, SC (US); Phillip V. Jones, North Myrtle Beach, SC (US)

(21) Appl. No.: 15/063,257

(22) Filed: Mar. 7, 2016

Related U.S. Application Data
(60) Provisional application No. 62/129,329, filed on Mar. 6, 2015.

(51) Int. Cl. A01J 23/00; B26D 3/18

(52) U.S. Cl. CPC A01J 23/00; B26D 3/18

(57) ABSTRACT

A device including a threaded pusher plate that engages into an interior thread of a cylinder housing. A square tube disposed inside the cylinder housing is configured to store a dairy product. A threaded pusher plate includes an interior cutout for engaging the square tube and a handle mechanism. A plurality of leg implements extends slightly to provide reduced friction against an exterior surface of the square tube. The invention cuts square-ended dairy products, such as, butter pats into circular pats of butter or margarine pats into circular pats of margarine.

### CROSS-REFERENCE TO RELATED APPLICATIONS

The present Utility patent application claims priority benefit of the U.S. provisional application for patent Ser. No. 62/129,329 entitled “BUTTER CUTTER” filed on 2015 Mar. 6 under 35 U.S.C. 119(e). The contents of this related provisional application are incorporated herein by reference for all purposes to the extent that such subject matter is not inconsistent herewith or limiting hereof.

### RELATED CO-PENDING U.S. PATENT APPLICATIONS

Not applicable.

### INCORPORATION BY REFERENCE OF SEQUENCE LISTING PROVIDED AS A TEXT FILE

Not applicable.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection by the author thereof. The copyright owner has no objection to the facsimile reproduction by anyone of the patent document or patent disclosure for the purposes of referencing as patent prior art, as it appears in the Patent and Trademark Office, patent file or records, but otherwise reserves all copyright rights whatsoever.

### BACKGROUND OF THE RELEVANT PRIOR ART

One or more embodiments of the invention generally relate to a cutting assembly. More particularly, certain embodiments of the invention relate to a cutting assembly for cutting a portion of a dairy product that provides a container portion that retains a dairy product for storage, and enables one handed rotational manipulation of the container portion to extrude the dairy product through a housing having a cutting portion, so as to cut a portion of the dairy product in predetermined dimensions.

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is that

Typically, butter is a solid dairy product made by churning fresh or fermented cream or milk, to separate the butterfat from the buttermilk. It is generally used as a spread on plain or toasted bread products and a condiment on cooked vegetables, as well as in cooking, such as baking, sauce making, and pan frying. Generally, butter consists of butterfat, milk proteins and water.

Generally, butter is kept either in an open dish such as a saucer, or in a special butter dish. While the special butter dish does protect the butter satisfactorily within a refrigerator or the like, at such time as the butter is being used, the entire length of the stick of butter may be exposed.

It is recognized that obtaining and selectively dispensing a portion of butter is often necessary whether the butter is warm or cold. When the butter is warm, uniform slices must be produced, producing more of a glob than a slice. When the butter is cold, cutting the butter is necessary to produce flat, uniform slices. A blade is effective for cutting pats of butter.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIGS. 1A and 1B illustrate blow up views of an exemplary cutting apparatus, where FIG. 1A illustrates an exemplary housing, and FIG. 1B illustrates an exemplary container portion, threaded pusher plate, and handle portion, in accordance with an embodiment of the present invention;

FIG. 2 illustrates a perspective views of an exemplary cutting apparatus, in accordance with an embodiment of the present invention;

FIG. 3 illustrates a sectioned side view of an exemplary cutting apparatus, in accordance with an embodiment of the present invention;

FIG. 4 illustrates a perspective view of an exemplary container portion, in accordance with an embodiment of the present invention;

FIG. 5 illustrates a perspective view of an exemplary container portion joined with an exemplary threaded pusher plate, in accordance with an embodiment of the present invention;

FIG. 6 illustrates a perspective view of an exemplary housing, showing an exemplary housing base end having a cutting portion and an outlet, in accordance with an embodiment of the present invention; and

FIG. 7 illustrates a perspective view of an exemplary portion of a dairy product, in accordance with an embodiment of the present invention.

FIG. 8 illustrates a sectioned top view of an exemplary threaded pusher plate, in accordance with an embodiment of the present invention;

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

All words of approximation as used in the present disclosure and claims should be construed to mean “approximate,” rather than “perfect,” and may accordingly be employed as a meaningful modifier to any other word, specified parameter, quantity, quality, or concept. Words of approximation, include, yet are not limited to terms such as “substantial”, “nearly”, “almost”, “about”, “generally”, “largely”, “essentially”, “closely approximate”, etc.

As will be established in some detail below, it is well settle law, as early as 1939, that words of approximation are not indefinite in the claims even when such limits are not defined or specified in the specification.

For example, see Ex parte Mallory, 52 USPQ 297, 297 (Pat. Off. Bd. App. 1941) where the court said “The examiner has held that most of the claims are inaccurate because apparently the laminar film will not be entirely eliminated. The claims specify that the film is “substantially” eliminated and for the intended purpose, it is believed that the slight portion of the film which may remain is negligible. We are of the view, therefore, that the claims may be regarded as sufficiently accurate.”

Note that claims need only “reasonably apprise those skilled in the art” as to their scope to satisfy the definiteness requirement. See Energy Absorption Sys., Inc. v. Roadway Safety Servs., Inc., Civ. App. 96-1264, slip op. at 10 (Fed. Cir. Jul. 3, 1997) (unpublished) Hybridtech v. Monoclonal Antibodies, Inc., 802 F.2d 1367, 1385, 231 USPQ 81, 94 (Fed. Cir. 1986), cert. denied, 480 U.S. 947 (1987). In addition, the use of modifiers in the claim, like “generally” and “substantial,” does not by itself render the claims indefinite. See Seattle Box Co. v. Industrial Crating & Packing, Inc., 731 F.2d 818, 828-29, 221 USPQ 568, 575-76 (Fed. Cir. 1984).

Moreover, the ordinary and customary meaning of terms like “substantially” includes “reasonably close to: nearly, almost, about”, connoting a term of approximation. See In re Frye, Appeal No. 2009-006013, 94 USPQ2d 1072, 1077, 2010 WL 889747 (B.P.A.I. 2010) Depending on its usage, the word “substantially” can denote either language of approximation or language of magnitude. Deering Precision Instruments, L.L.C. v. Vector Distribution Sys., Inc., 347 F.3d 1314, 1323 (Fed. Cir. 2003) (recognizing the “dual ordinary meaning of th[e] term [“substantially”] as connoting a term of approximation or a term of magnitude”). Here, when referring to the “substantially halfway” limitation, the Specification uses the word “approximately” as a substitute for the word “substantially” (Fact 4). (Fact 4). The ordinary meaning of “substantially halfway” is thus reasonably close to or nearly at the midpoint between the forwardmost point of the upper or outsole and the rearwardmost point of the upper or outsole.

Similarly, the term ‘substantially’ is well recognize in case law to have the dual ordinary meaning of connoting a term of approximation or a term of magnitude. See Dana Corp. v. American Axle & Manufacturing, Inc., Civ. App. 04-1116, 2004 U.S. App. LEXIS 18265, *13-14 (Fed. Cir. Aug. 27, 2004) (unpublished). The term “substantially” is commonly used by claim drafters to indicate approximation. See Cordis Corp. v. Medtronic AVE Inc., 339 F.3d 1352, 1360 (Fed. Cir. 2003) (“The patents do not set out any numerical standard by which to determine whether the thickness of the wall surface is ‘substantially uniform.’ The term ‘substantially,’ as used in this context, denotes approximation. Thus, the walls must be of largely or approximately uniform thickness.”); see also Deering Precision Instruments, LLC v. Vector Distribution Sys., Inc., 347 F.3d 1314, 1322 (Fed. Cir. 2003); Epcon Gas Sys., Inc. v. Bauer Compressors, Inc., 279 F.3d 1022, 1031 (Fed. Cir. 2002). We find that the term “substantially” was used in just such a manner in the claims of the patents-in-suit: “substantially uniform wall thickness” denotes a wall thickness with approximate uniformity.

It should also be noted that such words of approximation as contemplated in the foregoing clearly limits the scope of claims such as saying ‘generally parallel’ such that the adverb ‘generally’ does not broaden the meaning of parallel. Accordingly, it is well settled that such words of approximation as contemplated in the foregoing (e.g., like the phrase ‘generally parallel’) envisions some amount of deviation from perfection (e.g., not exactly parallel), and that such words of approximation as contemplated in the foregoing are descriptive terms commonly used in patent claims to avoid a strict numerical boundary to the specified parameter. To the extent that the plain language of the claims relying on such words of approximation as contemplated in the foregoing are clear and uncontradicted by anything in the written description herein or the figures thereof, it is improper to rely upon the present written description, the figures, or the prosecution history to add limitations to any of the claim of the present invention with respect to such words of approximation as contemplated in the foregoing. That is, under such circumstances, relying on the written description and prosecution history to reject the ordinary and customary meanings of the words themselves is impermissible. See, for example, Liquid Dynamics Corp. v. Vaughan Co., 355 F.3d 1361, 69 USPQ2d 1595, 1600-01 (Fed. Cir. 2004). The plain language of phrase 2 requires a “substantial helical flow.” The term “substantial” is a meaningful modifier implying “approximate,” rather than “perfect.” In Cordis Corp. v. Medtronic AVE, Inc., 339 F.3d 1352, 1361 (Fed. Cir. 2003), the district court imposed a precise numeric constraint on the term “substantially uniform thickness.” We noted that the proper interpretation of this term was “of largely or approximately uniform thickness” unless something in the prosecution history imposed the “clear and unmistakable disclaimer” needed for narrowing beyond this simple-language interpretation. Id. In Anchor Wall Systems v. Rockwood Retaining Walls, Inc., 340 F.3d 1298, 1311 (Fed. Cir. 2003)” Id. at 1311. Similarly, the plain language of claim 1 requires neither a perfectly helical flow nor a flow that returns precisely to the center after one rotation (a limitation that arises only as a logical consequence of requiring a perfectly helical flow).

The reader should appreciate that case law generally recognizes a dual ordinary meaning of such words of approximation, as contemplated in the foregoing, as connoting a term of approximation or a term of magnitude; e.g., see Deering Precision Instruments, L.L.C. v. Vector Distrib. Sys., Inc., 347 F.3d 1314, 68 USPQ2d 1716, 1721 (Fed. Cir. 2003), cert. denied, 124 S. Ct. 1426 (2004) where the court was asked to construe the meaning of the term “substantially” in a patent claim. Also see Epcon, 279 F.3d at 1031 (“The phrase ‘substantially constant’ denotes language of approximation, while the phrase ‘substantially below’ signifies language of magnitude, i.e., not insubstantial.”). Also, see, e.g., Epcon Gas Sys., Inc. v. Bauer Compressors, Inc., 279 F.3d 1022 (Fed. Cir. 2002) (construing the terms “substantially constant” and “substantially below”); Zodiac Pool Care, Inc. v. Hoffinger Indus., Inc., 206 F.3d 1408 (Fed. Cir. 2000) (construing the term “substantially inward”); York Prods., Inc. v. Cent. Tractor Farm & Family Ctr., 99 F.3d 1568 (Fed. Cir. 1996) (construing the term “substantially the entire height thereof”); Tex. Instruments Inc. v. Cypress Semiconductor Corp., 90 F.3d 1558 (Fed. Cir. 1996) (construing the term “substantially in the common plane”). In conducting their analysis, the court instructed to begin with the ordinary meaning of the claim terms to one of ordinary skill in the art. Prima Tek, 318 F.3d at 1148. Reference to dictionaries and our cases indicates that the term “substantially” has numerous ordinary meanings. As the district court stated, “substantially” can mean “significantly” or “considerably.” The term “substantially” can also mean “largely” or “essentially.” Webster's New 20th Century Dictionary 1817 (1983).

Words of approximation, as contemplated in the foregoing, may also be used in phrases establishing approximate ranges or limits, where the end points are inclusive and approximate, not perfect; e.g., see AK Steel Corp. v. Sollac, 344 F.3d 1234, 68 USPQ2d 1280, 1285 (Fed. Cir. 2003) where it where the court said [W]e conclude that the ordinary meaning of the phrase “up to about 10%” includes the “about 10%” endpoint. As pointed out by AK Steel, when an object of the preposition “up to” is nonnumeric, the most natural meaning is to exclude the object (e.g., painting the wall up to the door). On the other hand, as pointed out by Sollac, when the object is a numerical limit, the normal meaning is to include that upper numerical limit (e.g., counting up to ten, seating capacity for up to seven passengers). Because we have here a numerical limit—“about 10%”—the ordinary meaning is that that endpoint is included.

In the present specification and claims, a goal of employment of such words of approximation, as contemplated in the foregoing, is to avoid a strict numerical boundary to the modified specified parameter, as sanctioned by Pall Corp. v. Micron Separations, Inc., 66 F.3d 1211, 1217, 36 USPQ2d 1225, 1229 (Fed. Cir. 1995) where it states “It is well established that when the term “substantially” serves reasonably to describe the subject matter so that its scope would be understood by persons in the field of the invention, and to distinguish the claimed subject matter from the prior art, it is not indefinite.” Likewise see Verve LLC v. Crane Cams Inc., 311 F.3d 1116, 65 USPQ2d 1051, 1054 (Fed. Cir. 2002). Expressions such as “substantially” are used in patent documents when warranted by the nature of the invention, in order to accommodate the minor variations that may be appropriate to secure the invention. Such usage may well satisfy the charge to “particularly point out and distinctly claim” the invention, 35 U.S.C. §112, and indeed may be necessary in order to provide the inventor with the benefit of his invention. In Andrew Corp. v. Gabriel Elecs. Inc., 847 F.2d 819, 821-22, 6 USPQ2d 2010, 2013 (Fed. Cir. 1988) the court explained that usages such as “substantially equal” and “closely approximate” may serve to describe the invention with precision appropriate to the technology and without intruding on the prior art. The court again explained in Ecolab Inc. v. Envirochem, Inc., 264 F.3d 1358, 1367, 60 USPQ2d 1173, 1179 (Fed. Cir. 2001) that “like the term ‘about,’ the term ‘substantially’ is a descriptive term commonly used in patent claims to ‘avoid a strict numerical boundary to the specified parameter, see Ecolab Inc. v. Envirochem Inc., 264 F.3d 1358, 60 USPQ2d 1173, 1179 (Fed. Cir. 2001) where the court found that the use of the term “substantially” to modify the term “uniform” does not render this phrase so unclear such that there is no means by which to ascertain the claim scope.

Similarly, other courts have noted that like the term “about,” the term “substantially” is a descriptive term commonly used in patent claims to “avoid a strict numerical boundary to the specified parameter.”; e.g., see Pall Corp. v. Micron Seps., 66 F.3d 1211, 1217, 36 USPQ2d 1225, 1229 (Fed. Cir. 1995); see, e.g., Andrew Corp. v. Gabriel Elecs. Inc., 847 F.2d 819, 821-22, 6 USPQ2d 2010, 2013 (Fed. Cir. 1988) (noting that terms such as “approach each other,” “close to,” “substantially equal,” and “closely approximate” are ubiquitously used in patent claims and that such usages, when serving reasonably to describe the claimed subject matter to those of skill in the field of the invention, and to distinguish the claimed subject matter from the prior art, have been accepted in patent examination and upheld by the courts). In this case, “substantially” avoids the strict 100% nonuniformity boundary.

Indeed, the foregoing sanctioning of such words of approximation, as contemplated in the foregoing, has been established as early as 1939, see Ex parte Mallory, 52 USPQ 297, 297 (Pat. Off. Bd. App. 1941) where, for example, the court said “the claims specify that the film is “substantially” eliminated and for the intended purpose, it is believed that the slight portion of the film which may remain is negligible. We are of the view, therefore, that the claims may be regarded as sufficiently accurate.” Similarly, In re Hutchison, 104 F.2d 829, 42 USPQ 90, 93 (C.C.P.A. 1939) the court said “It is realized that “substantial distance” is a relative and somewhat indefinite term, or phrase, but terms and phrases of this character are not uncommon in patents in cases where, according to the art involved, the meaning can be determined with reasonable clearness.”

Hence, for at least the forgoing reason, Applicants submit that it is improper for any examiner to hold as indefinite any claims of the present patent that employ any words of approximation.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will be described in detail below with reference to embodiments thereof as illustrated in the accompanying drawings.

References to a “device,” an “apparatus,” a “system,” etc., in the preamble of a claim should be construed broadly to mean “any structure meeting the claim terms” exempt for any specific structure(s)/type(s) that has/(have) been explicitly disavowed or excluded or admitted/implied as prior art in the present specification or incapable of enabling an object/aspect/goal of the invention. Furthermore, where the present specification discloses an object, aspect, function, goal, result, or advantage of the invention that a specific prior art structure and/or method step is similarly capable of performing yet in a very different way, the present invention disclosure is intended to and shall also implicitly include and cover additional corresponding alternative embodiments that are otherwise identical to that explicitly disclosed except that they exclude such prior art structure(s)/step(s), and shall accordingly be deemed as providing sufficient disclosure to support a corresponding negative limitation in a claim claiming such alternative embodiment(s), which exclude such very different prior art structure(s)/step(s) way(s).

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” “some embodiments,” “embodiments of the invention,” etc., may indicate that the embodiment(s) of the invention so described may include a particular feature, structure, or characteristic, but not every possible embodiment of the invention necessarily includes the particular feature, structure, or characteristic. Further, repeated use of the phrase “in one embodiment,” or “in an exemplary embodiment,” “an embodiment,” do not necessarily refer to the same embodiment, although they may. Moreover, any use of phrases like “embodiments” in connection with “the invention” are never meant to characterize that all embodiments of the invention must include the particular feature, structure, or characteristic, and should instead be understood to mean “at least some embodiments of the invention” includes the stated particular feature, structure, or characteristic.

References to “user”, or any similar term, as used herein, may mean a human or non-human user thereof. Moreover, “user”, or any similar term, as used herein, unless expressly stipulated otherwise, is contemplated to mean users at any stage of the usage process, to include, without limitation, direct user(s), intermediate user(s), indirect user(s), and end user(s). The meaning of “user”, or any similar term, as used herein, should not be otherwise inferred or induced by any pattern(s) of description, embodiments, examples, or referenced prior-art that may (or may not) be provided in the present patent.

References to “end user”, or any similar term, as used herein, is generally intended to mean late stage user(s) as opposed to early stage user(s). Hence, it is contemplated that there may be a multiplicity of different types of “end user” near the end stage of the usage process. Where applicable, especially with respect to distribution channels of embodiments of the invention comprising consumed retail products/services thereof (as opposed to sellers/vendors or Original Equipment Manufacturers), examples of an “end user” may include, without limitation, a “consumer”, “buyer”, “customer”, “purchaser”, “shopper”, “enjoyer”, “viewer”, or individual person or non-human thing benefiting in any way, directly or indirectly, from use of. or interaction, with some aspect of the present invention.

In some situations, some embodiments of the present invention may provide beneficial usage to more than one stage or type of usage in the foregoing usage process. In such cases where multiple embodiments targeting various stages of the usage process are described, references to “end user”, or any similar term, as used therein, are generally intended to not include the user that is the furthest removed, in the foregoing usage process, from the final user therein of an embodiment of the present invention.

Where applicable, especially with respect to retail distribution channels of embodiments of the invention, intermediate user(s) may include, without limitation, any individual person or non-human thing benefiting in any way, directly or indirectly, from use of, or interaction with, some aspect of the present invention with respect to selling, vending, Original Equipment Manufacturing, marketing, merchandising, distributing, service providing, and the like thereof.

References to “person”, “individual”, “human”, “a party”, “animal”, “creature”, or any similar term, as used herein, even if the context or particular embodiment implies living user, maker, or participant, it should be understood that such characterizations are sole by way of example, and not limitation, in that it is contemplated that any such usage, making, or participation by a living entity in connection with making, using, and/or participating, in any way, with embodiments of the present invention may be substituted by such similar performed by a suitably configured non-living entity, to include, without limitation, automated machines, robots, humanoids, computational systems, information processing systems, artificially intelligent systems, and the like. It is further contemplated that those skilled in the art will readily recognize the practical situations where such living makers, users, and/or participants with embodiments of the present invention may be in whole, or in part, replaced with such non-living makers, users, and/or participants with embodiments of the present invention. Likewise, when those skilled in the art identify such practical situations where such living makers, users, and/or participants with embodiments of the present invention may be in whole, or in part, replaced with such non-living makers, it will be readily apparent in light of the teachings of the present invention how to adapt the described embodiments to be suitable for such non-living makers, users, and/or participants with embodiments of the present invention. Thus, the invention is thus to also cover all such modifications, equivalents, and alternatives falling within the spirit and scope of such adaptations and modifications, at least in part, for such non-living entities.

Headings provided herein are for convenience and are not to be taken as limiting the disclosure in any way.

The enumerated listing of items does not imply that any or all of the items are mutually exclusive, unless expressly specified otherwise.

It is understood that the use of specific component, device and/or parameter names are for example only and not meant to imply any limitations on the invention. The invention may thus be implemented with different nomenclature/terminology utilized to describe the mechanisms/units/structures/components/devices/parameters herein, without limitation. Each term utilized herein is to be given its broadest interpretation given the context in which that term is utilized.

Terminology. The following paragraphs provide definitions and/or context for terms found in this disclosure (including the appended claims):

“Comprising.” This term is open-ended. As used in the appended claims, this term does not foreclose additional structure or steps. Consider a claim that recites: “A memory controller comprising a system cache . . . . ” Such a claim does not foreclose the memory controller from including additional components (e.g., a memory channel unit, a switch).

“Configured To.” Various units, circuits, or other components may be described or claimed as “configured to” perform a task or tasks. In such contexts, “configured to” or “operable for” is used to connote structure by indicating that the mechanisms/units/circuits/components include structure (e.g., circuitry and/or mechanisms) that performs the task or tasks during operation. As such, the mechanisms/unit/circuit/component can be said to be configured to (or be operable) for perform(ing) the task even when the specified mechanisms/unit/circuit/component is not currently operational (e.g., is not on). The mechanisms/units/circuits/components used with the “configured to” or “operable for” language include hardware—for example, mechanisms, structures, electronics, circuits, memory storing program instructions executable to implement the operation, etc. Reciting that a mechanism/unit/circuit/component is “configured to” or “operable for” perform(ing) one or more tasks is expressly intended not to invoke 35 U.S.C. sctn. 112, sixth paragraph, for that mechanism/unit/circuit/component. “Configured to” may also include adapting a manufacturing process to fabricate devices or components that are adapted to implement or perform one or more tasks.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

The terms “a”, “an” and “the” mean “one or more”, unless expressly specified otherwise.

Unless otherwise indicated, all numbers expressing conditions, concentrations, dimensions, and so forth used in the specification and claims are to be understood as being modified in all instances by the term “about.” Accordingly, unless indicated to the contrary, the numerical parameters set forth in the following specification and attached claims are approximations that may vary depending at least upon a specific analytical technique.

The term “comprising,” which is synonymous with “including,” “containing,” or “characterized by” is inclusive or open-ended and does not exclude additional, unrecited elements or method steps. “Comprising” is a term of art used in claim language which means that the named claim elements are essential, but other claim elements may be added and still form a construct within the scope of the claim.

As used herein, the phase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phase “consisting essentially of” and “consisting of” limits the scope of a claim to the specified elements or method steps, plus those that do not materially affect the basis and novel characteristic(s) of the claimed subject matter (see Norian Corp. v Stryker Corp., 363 F.3d 1321, 1331-32, 70 USPQ2d 1508, Fed. Cir. 2004). Moreover, for any claim of the present invention which claims an embodiment “consisting essentially of” or “consisting of” a certain set of elements of any herein described embodiment it shall be understood as obvious by those skilled in the art that the present invention also covers all possible varying scope variants of any described embodiment(s) that are each exclusively (i.e., “consisting essentially of”) functional subsets or functional combination thereof such that each of these plurality of exclusive varying scope variants each consists essentially of any functional subset(s) and/or functional combination(s) of any set of elements of any described embodiment(s) to the exclusion of any others not set forth therein. That is, it is contemplated that it will be obvious to those skilled how to create a multiplicity of alternate embodiments of the present invention that simply consisting essentially of a certain functional combination of elements of any described embodiment(s) to the exclusion of any others not set forth therein, and the invention thus covers all such exclusive embodiments as if they were each described herein.

With respect to the terms” comprising,” “consisting of,” and “consisting essentially of,” where one of these three terms is used herein, the presently disclosed and claimed subject matter may include the use of either of the other two terms. Thus in some embodiments not otherwise explicitly recited, any instance of “comprising” may be replaced by “consisting of” or, alternatively, by “consisting essentially of”, and thus, for the purposes of claim support and construction for “consisting of” format claims, such replacements operate to create yet other alternative embodiments “consisting essentially of” only the elements recited in the original “comprising” embodiment to the exclusion of all other elements.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

The present invention will now be described in detail with reference to embodiments thereof as illustrated in the accompanying drawings.

There are various types of dairy product cutting devices that may be provided by preferred embodiments of the present invention. For example, the device may include a threaded pusher plate that may engage an interior thread of a cylinder housing. An interior cutout of the threaded pusher plate may include eight leg implements that extend slightly may provide reduced friction against an exterior of a square tube that houses a dairy product, which in turn may allow a smooth operation with less effort to use the device. The device may cut square-ended butter pats into circular pats of butter. The device may have a handle mechanism that significantly reduces a turning torque required to dispense the dairy product. For example, the device may dispense butter from a base of the device and may allow a user to properly position where the butter falls by means of a gradual sloping base within a circular wall inside the cylinder housing encapsulating the square tube.

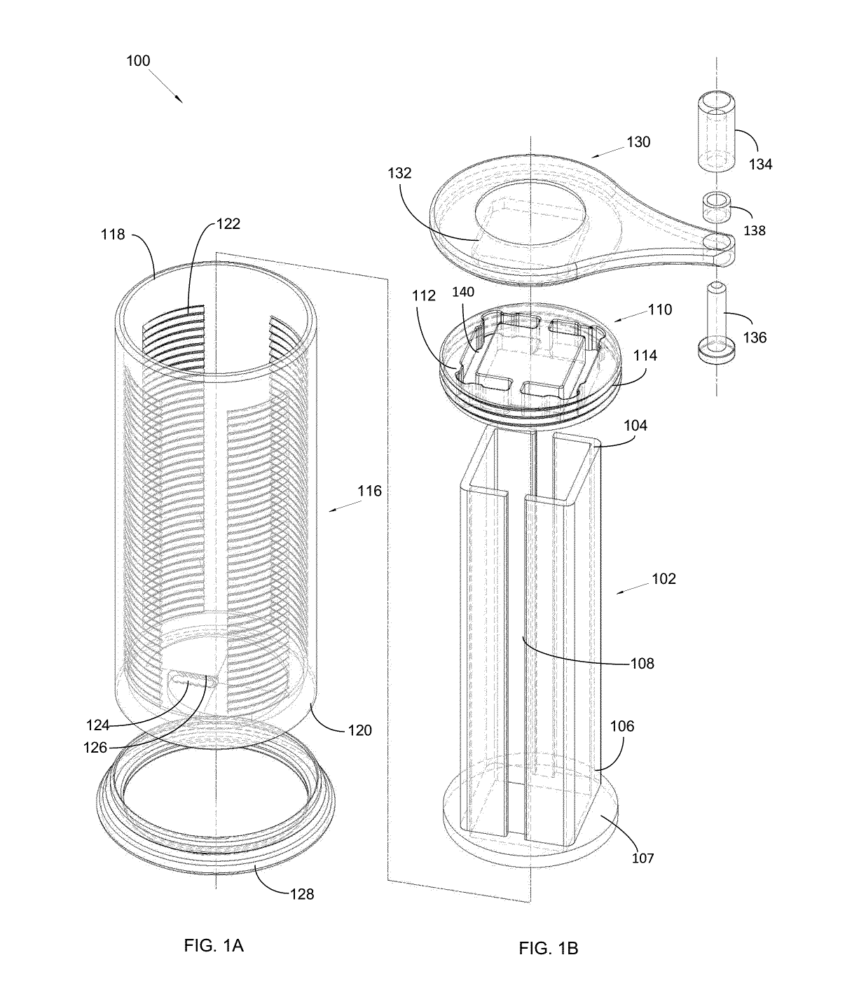

FIGS. 1A and 1B illustrate blow up views of an exemplary cutting assembly, where FIG. 1A illustrates an exemplary housing constituent, and FIG. 1B illustrates an exemplary container portion, pusher plate, and handle portion. In one embodiment of the present invention, a cutting assembly 100 is configured to retain a dairy product and enable simple manual cutting and dispensing of a portion of the dairy product. The cutting assembly may include a square or rectangular shaped tube and container portion 102 that retains the dairy product for storage. A threaded pusher plate threaded pusher plate 110 may rotatably extrude the dairy product through the container portion. A circular shaped cylindrical housing constituent 116 at least partially encapsulates the container portion. A cutting portion 124 and an outlet part 126 enable selective cutting and dispensing of a portion of the dairy product.

The pusher plate 110 and the housing 116 may be threaded, such that rotational manipulation of the threaded pusher plate relative to the housing is converted into a linear force that extrudes the dairy product through the cutting portion, and thereby enables cutting a portion of the dairy product in predetermined dimensions—often for single servings. Further, the assembly may be disposed at a desired orientation and position while cutting the dairy product to enable selective placement of the cut portion of dairy product. For example, without limitation, multiple circular and decorative pats of butter may be dispensed over a desired location.

Suitable materials for the assembly may include, without limitation, food grade plastics that are BPA free, clear polycarbonate plastic, stainless steel, and polymers. In some embodiments, injection molding may be used to fabricate the assembly.

In some embodiments, the assembly may comprise a container portion 102. The container portion may be, but not limited to, a square or rectangular shaped tube and may be sized and dimensioned for containing the dairy product. In one embodiment, the dairy product may include a rectangular stick of butter about six inches long. Though the dairy product may also include, without limitation, cheese, frozen yogurt, margarine, and pre-shaped dairy products having a generally solid constitution.

In some embodiments, the container portion may include at least a longitudinal slot segment 108 extending lengthwise. The longitudinal slots may be used to enable visual indication of the position of the dairy product as it is being extruded through the container portion. In some embodiments the container portion may include at least two longitudinal slot segments extending lengthwise.

In some embodiments, the container portion 102 may include a container open end 106 for receiving the dairy product. Container portion 102 may include a centering disk 107, which may be designed to have a diameter smaller than that of perimeter base 128 to enable them to mate one within the other such that centering disk 107 may act like a slip ring to permit rotation of container portion 102 with relatively lower friction while stabilizing it from wobbling as handle gear 132 is turning the whole assemble. The container portion and container open end may be rectangular, so as to receive a stick of butter. The container portion 102 may further include a container gear end 104. The container gear end operatively connects with other components of the assembly to enable conversion of rotational force to a linear displacement, thereby extruding the dairy product towards the container open end of the container portion. The container portion may have various lengths, widths and heights, so as to receive various sizes of dairy products such as, but not limited to, butter sticks, margarine sticks, etc.

In some embodiments, the assembly may further comprise a housing 116. The housing is configured to receive the container portion. In one embodiment, the housing may have a generally cylindrical shape that is sized to fully receive the container portion 102 and also to enable rotation of the container portion relative to the housing. The housing may include a housing open end 118 through which the container portion enters.

The housing may further include a housing base end 120 that substantially closes one end of the housing. The base end 120 may include a gradually sloping base end. The housing base end may include a cutting portion, through which the dairy product is cut. The cutting portion may include an elongated blade having a smooth or serrated configuration. The blade is disposed adjacent to an outlet, such that the blade feeds the outlet a cut off portion of the dairy product and the gradual slope of the base end allows the cut off portion of the dairy product to exit through the outlet in a sliding motion.

In some embodiments, the housing may also include a threaded inner surface 122. The threaded inner surface may extend along a substantial portion of the length of the housing. The extended disposition of the threaded inner surface enables rotational force to be converted into a linear force that extrudes the dairy product along the length of the container portion.

In one possible embodiment, the threaded inner surface of the housing may include vertically fluted threads. Those skilled in the art will recognize that vertically fluted threads are configured so as to not make a full revolution, as in typical interior threading. Instead, the thread pattern is divided into four equal sections of threaded vertical areas and four equal sections that are unthreaded. The unthreaded vertical areas allow a user who is using the assembly to view the rotation of the butter device as well as determine the amount of stick butter remaining in the tube.

In some embodiments, a perimeter base 128 may join with the housing base end. The perimeter base may include an annular member that provides a supportive foundation for the housing when resting in an upright position. The perimeter base may join with the housing base end through a friction fit connection, a threaded connection, a fastener, a magnet, or other appropriate fastening mechanism.

In some embodiments, the assembly may further comprise a threaded pusher plate 110. The threaded pusher plate may be configured to fixedly join with the container gear end 104 of the container portion. The threaded pusher plate may further be configured to enable rotation of the container portion relative to the housing. The threaded pusher plate may then convert the rotation into a linear force to extrude the dairy product through the container portion, and out through the cutting portion and outlet of the housing.

In one embodiment, the threaded pusher plate 110 may have a generally circular shape that is sized to form a snug fit within the cylindrical shaped housing 116. The pusher plate may include an interior cutout portion 140 for receiving the container gear end 104 of the container portion on one end and the handle gear 132 on the other end. The container gear end 104 and the handle gear 132 connects and forms a unitary unit inside the cutout portion 140. The threaded pusher plate may also include a threaded perimeter portion 114 that is configured to rotatably engage the threaded inner surface 122 of the housing 116. In one embodiment, the threaded pusher plate 110 may further include a plurality of leg implements 112 that extend slightly, surrounding the interior cutout portion 140, to form a snug fit on the exterior of the container portion 102 that retains the dairy product for storage. The plurality of leg implements may provide a reduced friction against the container portion, which in turn allows the butter cutter a much smoother operation. One aspect of interior cutout portion 140 in the present embodiment is to have an enlarged cutout area offset from the exterior walls of container portion 102 so as to reduce the surface area of the threaded pusher plate. In other embodiment, the entire vertical wall surface of pusher plate 110 may contact the outer walls of container portion 102; however, in many practical application, this may significantly increase surface friction and binding conditions, thereby significantly increasing the effort required to force downward pusher plate 110 under normal operation of the apparatus. Similarly, if the threading or sliding friction is too great, the apparatus may bind and fail to rotate as freely due to a high degree of said frictional forces.

The plurality of leg implements may also provide other functional benefits in many practical applications, which by way of example, and not limitation, may include providing stability with far less friction between the parts contacting each other, and the leg implements reduce the surface area of the two parts touching. To reduce such friction, contacting components may be made of suitable low friction materials known to those skilled in the art, which may include materials such as nylon, Teflon™, etc. In some embodiments, the plurality of leg implements 112 may include, but not limited to, at least eight leg implements. Four of the leg implements may touch the container portion 102 at any given time so as to further reduce the friction of operation. For instance, four of the leg implements may touch a first section of the container portion 102 in a clockwise operation of the assembly whereas the other four legs of the eight legs may touch a second section of the container portion 102 when rotated counterclockwise. In other embodiments, the plurality of leg implements 112 may include, but not limited to, more or less than eight leg implements. In other embodiments, the leg implements 112 may comprise any desirable number of them, or not be included at all, depending upon the needs of the particular application. In other embodiments, the plurality of leg implements 112 may be shaped and/or distributed in a multiplicity of other ways depending upon the needs of the specific application, as will be apparent to those skilled in the art in light of the present invention. By way of example, and not limitation, the leg implements may be otherwise designed as rounded, curved, tapered, straight, different widths or heights, slotted, perforations, fringed edges, and be of any suitable number as needed by the particular application, including none. Leg implements 112 may also be designed as general protrusions, extensions, arms, and/or rails.

Thus, in one embodiment, rotation of the threaded pusher plate in a first direction while the threaded portions 114 and 122 are engaged causes the threaded pusher plate to move linearly from the container gear end 104 to the container inlet end of the container portion. This works to extrude the dairy product through the housing before engaging the cutting portion and outlet in the housing for dispensing the desired portion of dairy product. Furthermore, rotation of the threaded pusher plate in the first direction may be used to clean out the container portion of excess dairy product.

Conversely, rotating the threaded pusher plate in a second direction while the threaded portions are engaged causes the threaded pusher plate to move linearly from the container inlet end to the container gear end of the container portion. This may be useful when loading fresh dairy product into the container portion.

In an embodiment, for a rotation of the threaded pusher plate, one end of the interior cutout portion 140 of the pusher plate receives the container gear end 104 of the container portion and the other end of the cutout portion receives the handle gear 132 of a handle portion 130. The threaded pusher plate may include a plurality of leg implements 112 around the cutout portion 140 to form a snug fit of the container gear end 104 and handle gear 132 within the cutout portion 140. The handle gear 132 enables the handle portion 130 to engage and rotatably articulate the threaded pusher plate.

In some embodiments, the handle portion 130 may be disposed to operate proximal to the container gear end of the container. The handle portion is configured to operate the threaded pusher plate, and specifically rotate the threaded pusher plate in the first or second direction, as needed. The handle portion may include a square shaped handle gear 132 that operatively couples to container gear end 104 and may be held in place by the plurality of leg implements 112. The handle gear 132 typically couples to container gear end 104 above the cutout portion 140 and the plurality of leg implements 112 are configured to mate with the outer walls of container portion 102 so that a rotational force applied to the handle portion efficiently converts to rotational screwing of the threaded perimeter portion of the pusher plate along threaded portions 122 of cylindrical shaped housing 116.

In some embodiments, the handle portion may include a grip implement 134 that extends therefrom to enable a smooth manipulation of the handle portion. In one embodiment, the grip implement is a rotating knob. In one embodiment, the grip, or handle knob, rests on a bushing 138 and is secured to the handle portion with a flat headed pin. The grip implement may spin freely within the handle portion when rotated in either direction. A cylinder cap may snap on the base of the housing for storage. In some embodiments, at least one fastener or pin 136 may help fasten the grip implement to the handle portion. The fastener may include, without limitation, a screw, a nail, a magnet, an adhesive, and a friction fit seal. The bushing 138 includes, but not limited to, a nylon or plastic bushing which may allow the fastener or pin 136 to spin 360 degrees as the handle portion is turned.

In other embodiments, the handle portion may be fabricated from ABS plastic or polycarbonate. The handle portion may also include a recessed disk area within the center top area of the handle portion whereby a labeling component may be added to display the brand or logo of the assembly. The grip may also be fabricated from ABS plastic and have a fastener, such as a pin, that secures it through the handle portion. The grip bushing may be fabricated from nylon or UHMW (ultra-high molecular weight polyethylene), plastic which has low wear and low friction characteristics.

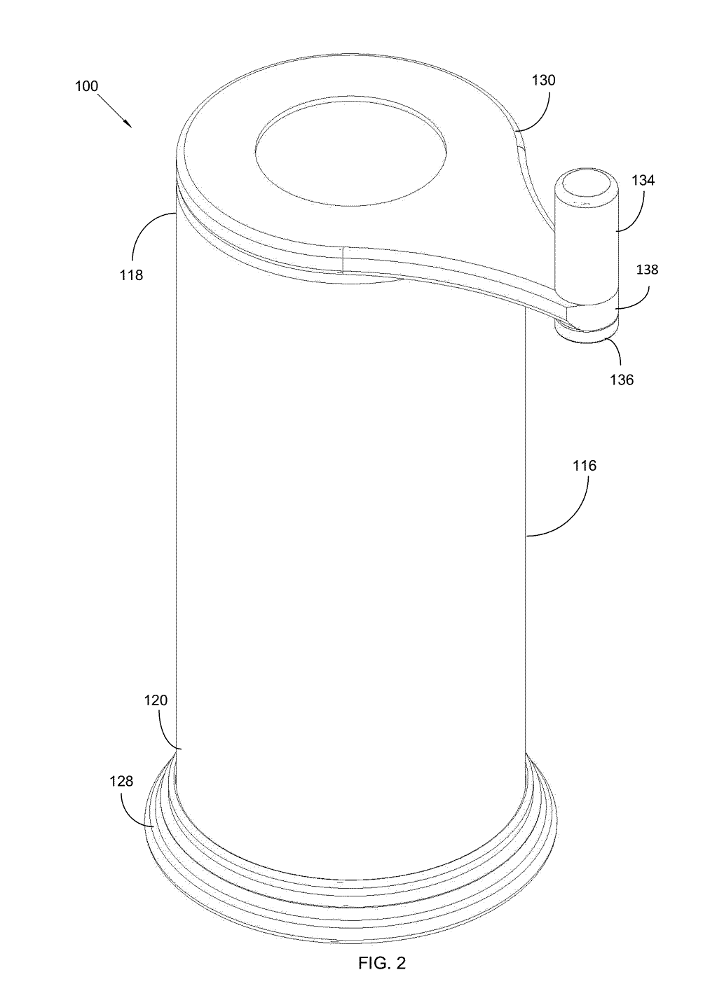

FIG. 2 illustrates a perspective views of an exemplary cutting apparatus. In one aspect, operation of the assembly is manual and may be possible with one hand. The housing may be held by one hand and the handle portion held with the other hand. The handle is then rotated clockwise which in turn rotates the interior square container portion holding the stick of butter. The butter may rotate within the container portion through engagement between the threaded perimeter portion of the threaded pusher plate, and the threaded inner surface of the housing.

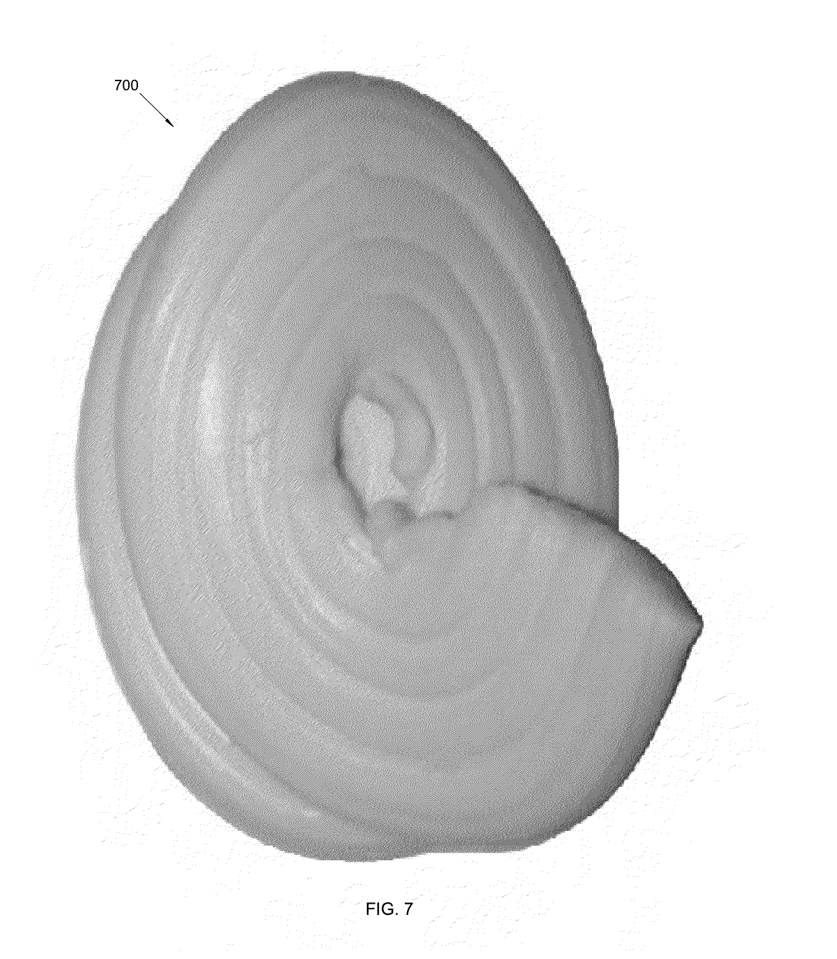

In one operational embodiment of the assembly, the housing base end is removed from the housing. A user holds the housing with one hand and the grip of the handle portion with the other hand and turns the handle portion counter-clockwise to release the interior container which holds a butter stick. The butter stick may then be inserted in the container open end. Once the butter is inserted into the container portion, the container portion is then re-inserted into the housing and rotated clockwise. This causes the threaded perimeter portion of the threaded pusher plate to engage the threaded inner surface of the housing. Each full clockwise rotation turn of the handle portion may produce one rounded pat of cut butter or margarine, as FIG. 7 illustrates below. The butter stick turns clockwise with the container portion and rotates into the cutting portion in the housing base end.

The assembly provides numerous advantageous over existing butter dishes because: a) the assembly does not require a hand held knife to cut the butter, b) the assembly stands vertically and therefore requires less space in the refrigerator or table top, c) the assembly eliminates the butter stick from repeated human touching and handling, d) the assembly eliminates food debris and cross-contamination from other people's eating utensils, e) the assembly cuts the butter into uniform rounded pats, f) the assembly helps keeps insects and airborne particles off the butter stick.

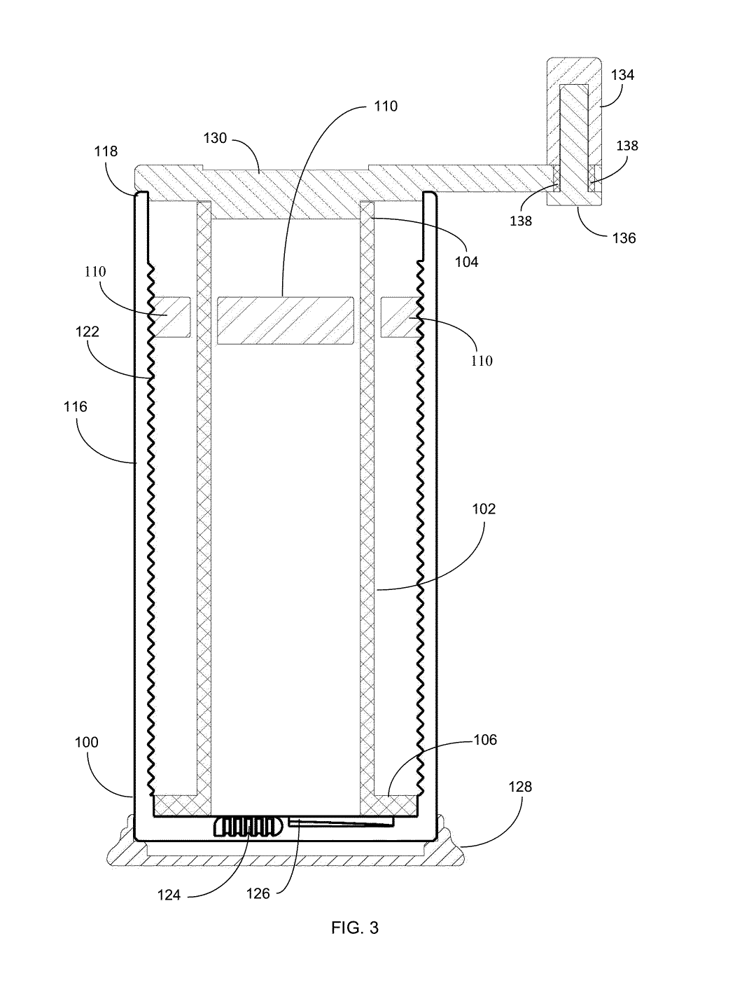

FIG. 3 illustrates a sectioned side view of an exemplary cutting apparatus, in accordance with an embodiment of the present invention. In one aspect, the dimensions of each component of the assembly may be adapted to cut different types and sizes of dairy products. For example, FIG. 3 illustrates a generally rectangular container portion. However, the container portion may be cylindrical to receive a cylindrical stick of butter. The threaded perimeter portion 114 of the pusher plate 110 may engage the threaded inner surface 122 of the cylindrical housing 116. In the present embodiment, container gear end 104 mates into handle gear 132 whereby turning of handle portion 130 can turn container portion 102 to thereby turn threaded pusher plate 110 and slide it up/down the container portion 102 shaft by a screwing action along threaded inner surface 122, as shown. An interior cutout 140 of the threaded pusher plate may contain eight leg implements 112 that extend slightly out and may provide reduced friction against an exterior of the container portion 102, which in turn may allow a smooth operation with less effort to use the apparatus. The apparatus may cut square-ended butter pats into circular pats of butter. The handle portion 130 significantly reduces a turning torque required to dispense the butter. The device may dispense butter from the base end 120 of the apparatus and may allow a user to properly position where the butter falls by means of a gradually sloping base end 120 within the circular shaped cylinder housing 116.

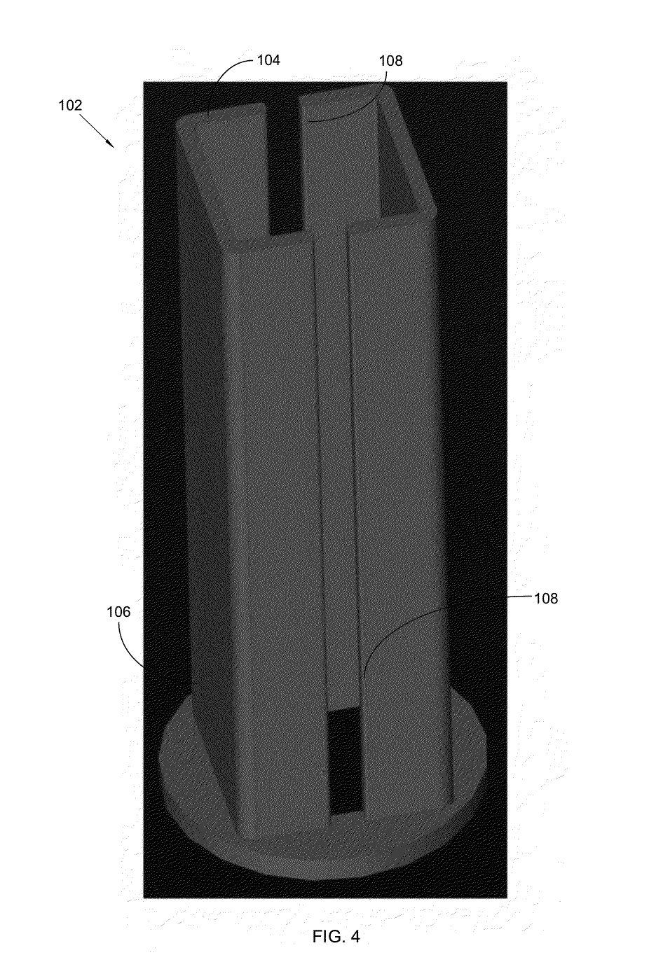

FIG. 4 illustrates a perspective view of an exemplary container portion, in accordance with an embodiment of the present invention. In one aspect, the container portion not only serves as a stationary base that enables passage of the dairy product, but also provides a sanitary containment of the dairy product when not in use. Those skilled in the art will recognize that butter dishes often leave the butter exposed to other odors in the refrigerator as well as exposure to food particles and allergens on shared eating utensils. The butter cutter is enclosed in the container portion, and thus cuts butter.

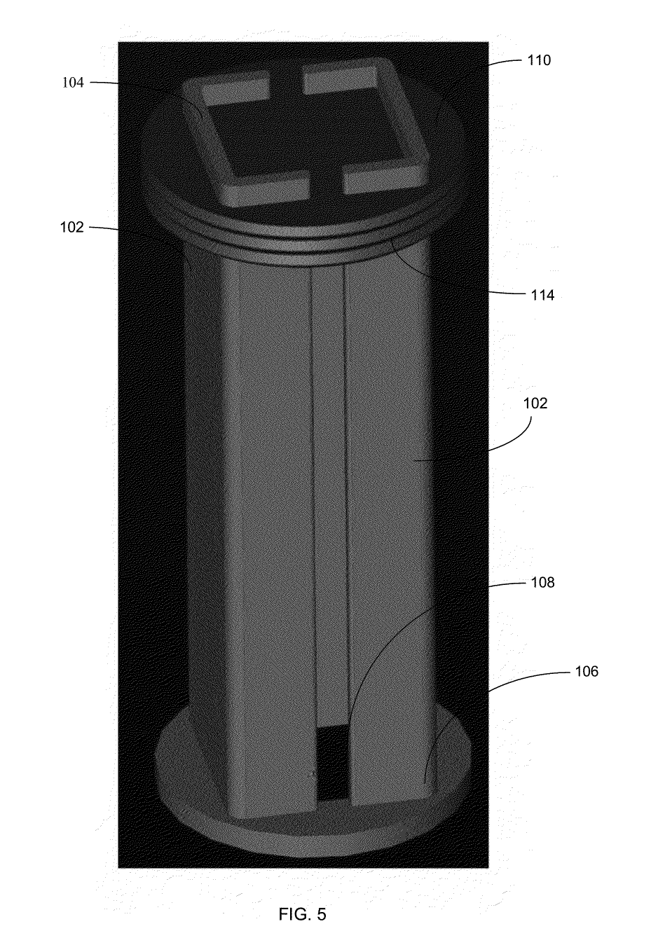

FIG. 5 illustrates a perspective view of an exemplary container portion joined with an exemplary threaded pusher plate, in accordance with an embodiment of the present invention. In one aspect, the threaded pusher plate rotatably slides up and down the container portion to extrude the dairy product through the outlet in the housing base end. It should be noted that the leg implements 112 are not shown in the illustrated embodiment to demonstrate their optionality, yet, as explained above, leg implements 112 may be readily included or not depending on the needs of the particular application. The threaded pusher plate may be configured with seals, various thicknesses, and unique threads, so as to create a faster or slower displacement along the length of the container portion.

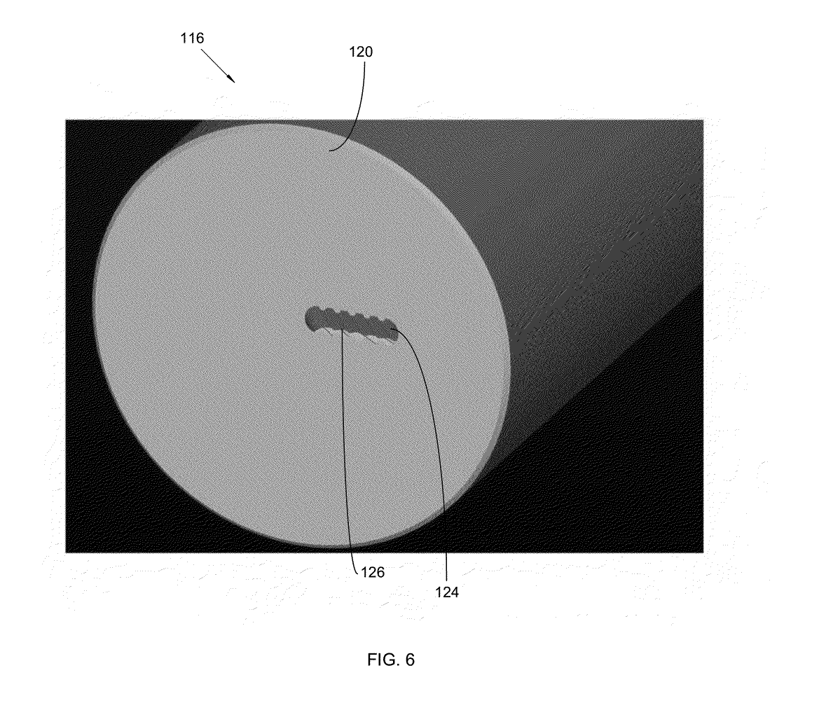

FIG. 6 illustrates a perspective view of an exemplary housing, in accordance with an embodiment of the present invention, showing an exemplary housing base end having a cutting portion and an outlet. In one aspect, the cutting portion may include a stainless steel blade that is sufficiently sharp, so as to cut harder, cold butter or other dairy products. Those skilled in the art will recognize that cold stick butter is very difficult to cut. Additionally, the assembly may be used to cut stick margarine or soft cheeses, such as, but not limited to stick cream cheese.

FIG. 7 illustrates a perspective view of an exemplary portion of a dairy product, in accordance with an embodiment of the present invention. In one aspect, the dairy product may be extruded from the outlet as a generally round pat of butter, as illustrated in FIG. 7. The assembly is unique in cutting the dairy product, and specifically butter. Those skilled in the art, in light of the present teachings, will recognize that butter is a solid dairy product made by churning fresh or fermented cream or milk, to separate the butterfat from the buttermilk.

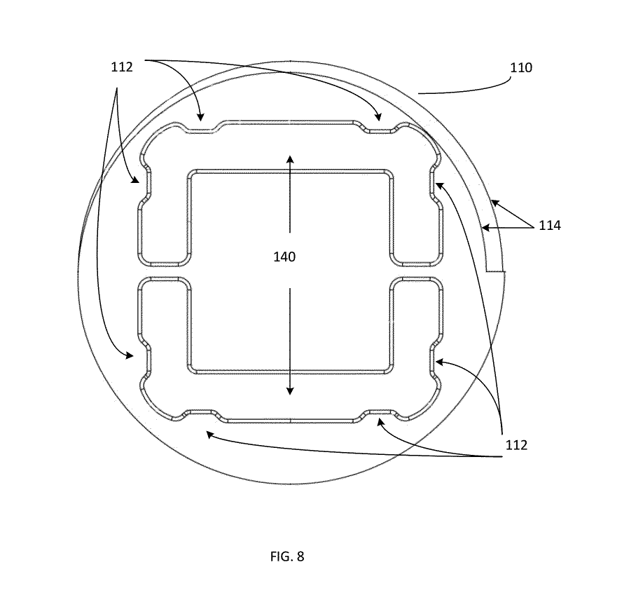

FIG. 8 illustrates a sectioned top view of an exemplary threaded pusher plate, in accordance with an embodiment of the present invention. In one aspect, the pusher plate 110 may have a generally outer circular shape that is sized to form a snug fit within the cylinder housing 116. An interior cutout area 140 is dimensioned to loosely receive the container gear end 104 of the container portion 102 and the handle gear 132 of the handle portion 130. A plurality of leg implements 112 may extend slightly and surround the outer perimeter of the interior cutout area 140. The plurality of leg implements 112 may form a snug fit with the container gear end and handle gear. A threaded perimeter portion 114 is configured to rotatably engage the threaded inner surface 132 of the cylinder housing 116. The handle gear 132 enables the handle portion 130 to engage and rotatably articulate the pusher plate. In one embodiment, the plurality of leg implements 112 may provide a reduced friction against an outer surface of the container portion 102, which in turn allows a smoother articulation of the pusher plate.

Butter is generally used as a spread on plain or toasted bread products and a condiment on cooked vegetables, as well as in cooking, such as baking, sauce making, and pan frying. Butter consists of butterfat, milk proteins and water. Thus, the assembly enables selective sizing of the extruded portion of butter, along with sufficient mobility so that the cut portion of butter can be placed in a specific location.

In one alternative embodiment, the assembly, and specifically the cutting portion is configured to cut malleable materials beyond dairy products. In another alternative embodiment, the container portion takes other shapes, including, without limitation, cylindrical, triangular, and octahedral. In yet another alternative embodiment, multiple cutting portions may be used to create a more artistic shape for the dairy product.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC §112 (1), all claims must be supported by sufficient disclosure in the present patent specification, and any material known to those skilled in the art need not be explicitly disclosed. However, 35 USC §112 (6) requires that structures corresponding to functional limitations interpreted under 35 USC §112 (6) must be explicitly disclosed in the patent specification. Moreover, the USPTO's Examination policy of initially treating and searching prior art under the broadest interpretation of a “mean for” claim limitation implies that the broadest initial search on 112(6) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC §112 (6) when such corresponding structures are not explicitly disclosed in the foregoing patent specification. Therefore, for any invention element(s)/structure(s) corresponding to functional claim limitation(s), in the below claims interpreted under 35 USC §112 (6), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC §112 (6) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC §112 (6), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC §112 (6). Applicant(s) note that all the identified documents above which are incorporated by reference to satisfy 35 USC §112 (6) necessarily have a filing and/or publication date prior to that of the instant application, and thus are valid prior documents to incorporated by reference in the instant application.

Having fully described at least one embodiment of the present invention, other equivalent or alternative methods of implementing a cutting assembly that is configured to retain a dairy product and enable simple one-handed cutting of a portion of the dairy product according to the present invention will be apparent to those skilled in the art. Various aspects of the invention have been described above by way of illustration, and the specific embodiments disclosed are not intended to limit the invention to the particular forms disclosed. The particular implementation of the cutting assembly that is configured to retain a dairy product and enable simple one-handed cutting of a portion of the dairy product may vary depending upon the particular context or application. By way of example, and not limitation, the cutting assembly that is configured to retain a dairy product and enable simple one-handed cutting of a portion of the dairy product described in the foregoing were principally directed to a butter cutting assembly that rotatably extrudes a stick of butter through a blade for selective dispensing of a pat of butter implementations; however, similar techniques may instead be applied to cutting nondairy objects, such as foam, wood, and jelly, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The Abstract is provided to comply with 37 C.F.R. Section 1.72(b) requiring an abstract that will allow the reader to ascertain the nature and gist of the technical disclosure. That is, the Abstract is provided merely to introduce certain concepts and not to identify any key or essential features of the claimed subject matter. It is submitted with the understanding that it will not be used to limit or interpret the scope or meaning of the claims.

The following claims are hereby incorporated into the detailed description, with each claim standing on its own as a separate embodiment.

What is claimed is:

1. A device comprising:
a cylinder housing constituent, wherein said cylinder housing section comprises at least a threaded inner surface;
a square tube section disposed inside said cylinder housing constituent, wherein said square tube section being configured to be operable for storing a dairy product;
a pusher plate comprising:
an interior cutout area configured to couple with an end of said square tube section; and
a threaded perimeter portion configured to engage said threaded inner surface;
a handle mechanism configured to be operable to engage and rotatably articulate the pusher plate; and
a base comprising;
a cutting portion configured to enable cutting a portion of the dairy product; and
an outlet portion configured to enable dispensing the cut portion of the dairy product, wherein said base is configured to be operable to allow the dairy product to fall by means of a gradual sloping circular wall inside said base.

2. The device of claim 1, in which said square tube section comprising a longitudinal slot segment configured to enable a visual indication of a position of the dairy product.

3. The device of claim 1, in which said pusher plate further comprises a leg implement, wherein said leg implement comprises at least a plurality of leg implements disposed around said interior cutout area.

4. A device comprising:
a cylinder housing, wherein said cylinder housing comprises interior threads;
a threaded pusher plate implement configured to be operable to engage said interior threads of said cylinder housing;
a square tube section disposed inside said cylinder housing, wherein said square tube being configured to be operable to hold a dairy product, said square tube having an exterior surface;
a leg implement, said leg implement comprises at least a plurality of leg implements disposed in an interior cutout of said threaded pusher plate, wherein said plurality of leg implements being configured to be operable to at least reduce a friction against said exterior surface of said square tube section;
a handle mechanism configured to be operable to significantly reduce a turning torque required to dispense the dairy product; and
a base, wherein said base is configured to be operable to allow the dairy product to fall by means of a gradual sloping circular wall inside said base.

5. The device of claim 4, further comprising a cutting portion.

6. The device of claim 5, further comprising an outlet part.

7. The device of claim 6, further comprising a longitudinal slot segment that is configured to enable visual indication of a position of the dairy product as it is being extruded through said square tube section.

8. The device of claim 4, further comprising a container gear end.

9. The device of claim 6, further comprising a container open end configured to be operable for receiving the dairy product.

10. The device of claim 6, further comprising a housing open end through which said threaded pusher plate enters.

11. The device of claim 6, further comprising a housing base end.

12. The device of claim 6, further comprising a perimeter base.

13. The device of claim 6, further comprising a threaded perimeter portion.

14. The device of claim 4, further comprising a handle portion.

15. The device of claim 14, further comprising a grip implement.

16. The device of claim 15, further comprising at least one fastener configured to fasten said grip implement to said handle portion.

17. The device of claim 16, further comprising at least nylon or plastic bushing that is configured to be operable for allowing said fastener to spin 360 degrees as said handle portion is turned.

18. A device comprising:
means for retaining a dairy product;
means for encapsulating said retaining means, wherein said encapsulating means comprises interior threads;
means for pushing the dairy product, wherein said pushing means comprises a threaded surface configured to be operable to engage said interior threads of said encapsulating means;
means for reducing friction against an exterior surface of said pushing means;
means for operating said pushing means;
means for cutting a portion of the dairy product; and
means for dispensing the cut portion of the dairy product.

19. The device of claim 18, further comprising means for enabling a visual indication of the position of the dairy product as it is being extruded through said encapsulating means.

20. The device of claim 19, further comprising means for providing a supportive foundation for said encapsulating means when resting in an upright position.
